(19) United States
(12) Patent Application Publication
(10) Pub. No.: US 2016/0292874 A1
(43) Pub. Date: Oct. 6, 2016

(54) METHODS AND SYSTEMS FOR AUTOMATIC SEGMENTATION

(71) Applicant: General Electric Company, Schenectady, NY (US)

(72) Inventors: Jiang Hsieh, Brookfield, WI (US); William David Doan, Frisco, TX (US); Paul Roger Anderson, Bloomfield Hills, MI (US)

(21) Appl. No.: 14/673,650

(22) Filed: Mar. 30, 2015

(51) Int. Cl. G06T 7/00; G06T 11/00

(52) U.S. Cl. CPC G06T 7/0079; G06T 11/003; G06T 2207/10081; G06T 2207/10004

(57) ABSTRACT

Methods and systems are provided for reconstructing and automatically segmenting an image. In one embodiment, a method comprises generating a first image from acquired projection data based on an iterative reconstruction algorithm, generating a second image from the acquired projection data based on a modified iterative reconstruction algorithm, segmenting the second image to obtain segments, segmenting the first image based on the segments of the second image, and outputting the segmented first image to a display. In this way, an image which may otherwise prove challenging for an automatic segmentation process may be accurately segmented without sacrificing textural details of the image.

### FIELD

Embodiments of the subject matter disclosed herein relate to non-invasive diagnostic imaging, and more particularly, to automatic segmentation of diagnostic images.

### BACKGROUND

Non-invasive imaging technologies allow images of the internal structures of a patient or object to be obtained without performing an invasive procedure on the patient or object. In particular, technologies such as computed tomography (CT) use various physical principals, such as the differential transmission of x-rays through the target volume, to acquire image data and to construct tomographic images (e.g., three-dimensional representations of the interior of the human body or of other imaged structures).

One of the key tasks in oncology is to automatically perform segmentation of reconstructed images to identify organs and other anatomical structures. Unfortunately, many segmentation algorithms are often distracted by the presence of noise and fail to identify correct organ boundaries. For example, since the invention of CT, filtered backprojection (FBP) has been used almost exclusively for image reconstruction because of its computational efficiency. However, one disadvantage of FBP is its suboptimal noise and image quality performance resulting from simplifications made in order to derive the closed form analytic solution. In contrast, iterative reconstruction (IR) algorithms feature substantially reduced noise levels in reconstructed images compared to FBP reconstructed images of the same scanning data. However, IR is still too noisy for automatic segmentation of images due to variations in intensity within anatomical structures in the image. The difficulty is further enhanced by the organ variations from patient to patient. A more reliable and automated organ segmentation is highly desirable for workflow and productivity.

### BRIEF DESCRIPTION

In one embodiment, a method comprises generating a first image from acquired projection data based on an iterative reconstruction algorithm, generating a second image from the acquired projection data based on a modified iterative reconstruction algorithm, segmenting the second image to obtain segments, segmenting the first image based on the segments of the second image, and outputting the segmented first image to a display. In this way, an image which may otherwise prove challenging for an automatic segmentation process may be accurately segmented without sacrificing textural details of the image. Instead of relying on additional complexity and features of a segmentation algorithm, the reconstruction itself is modified in order to improve the reliability and robustness of the segmentation algorithm.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a pictorial view of an imaging system according to an embodiment of the invention.

FIG. 2 shows a block schematic diagram of an exemplary imaging system according to an embodiment of the invention.

FIG. 3 shows a high-level flow chart illustrating an example method for generating an automatically segmented image according to an embodiment of the invention.

FIG. 4 shows an example image reconstructed with a normal iterative reconstruction algorithm according to an embodiment of the invention.

FIG. 5 shows an example image reconstructed with a modified iterative reconstruction algorithm according to an embodiment of the invention.

FIG. 6 shows a high-level flow chart illustrating an example method for generating an automatically segmented image according to an embodiment of the invention.

### DETAILED DESCRIPTION

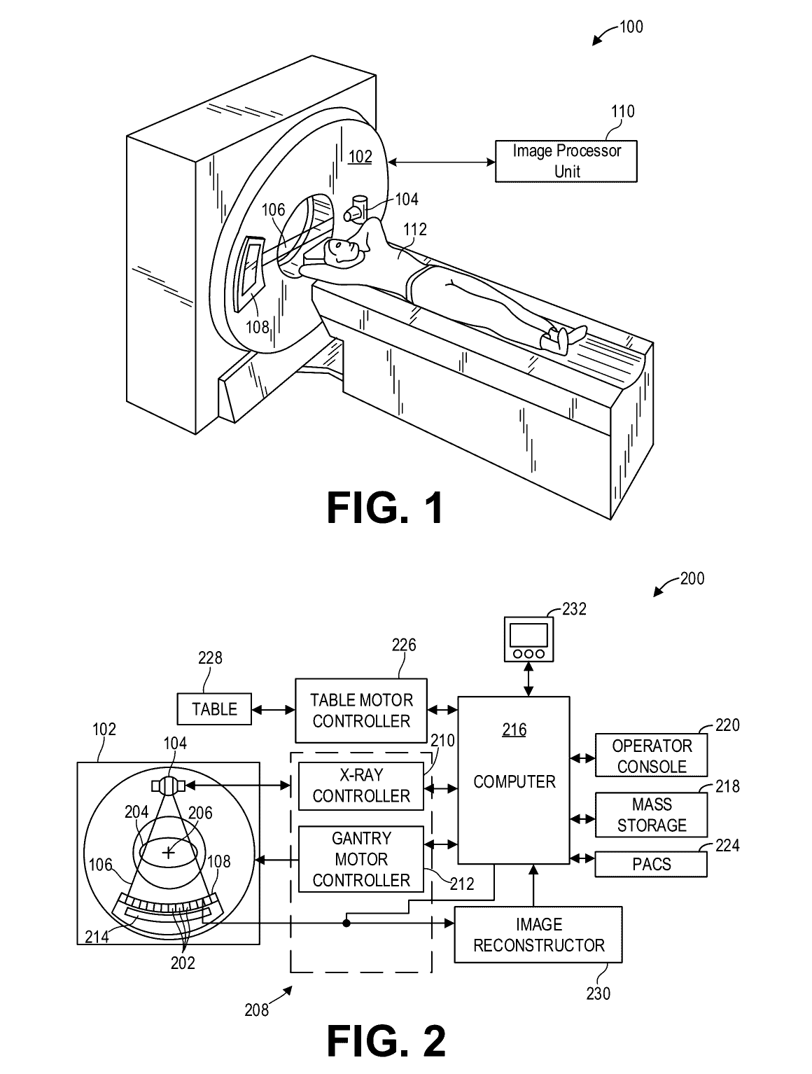

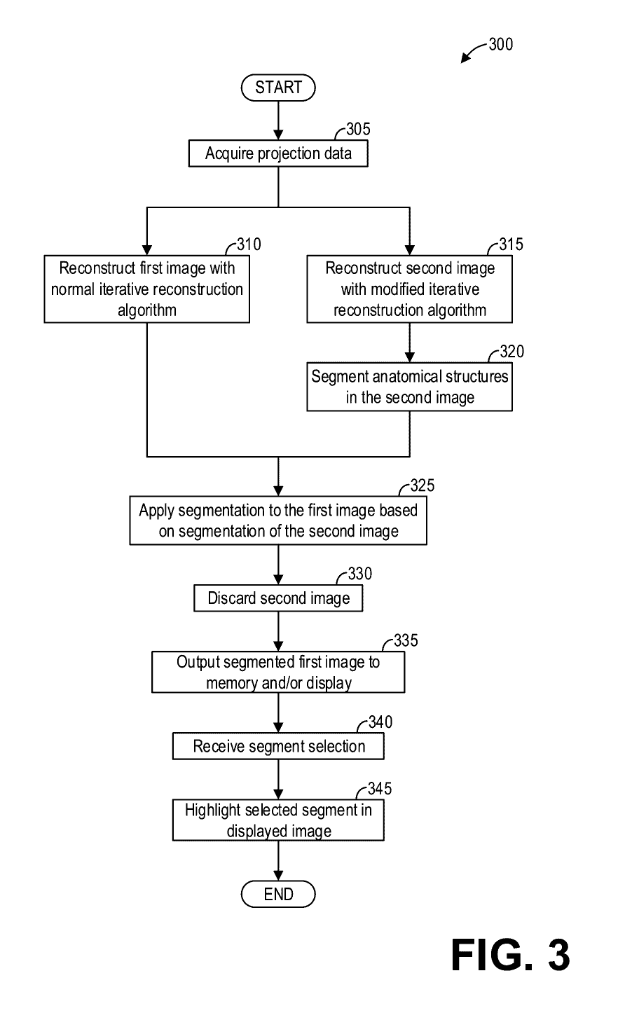

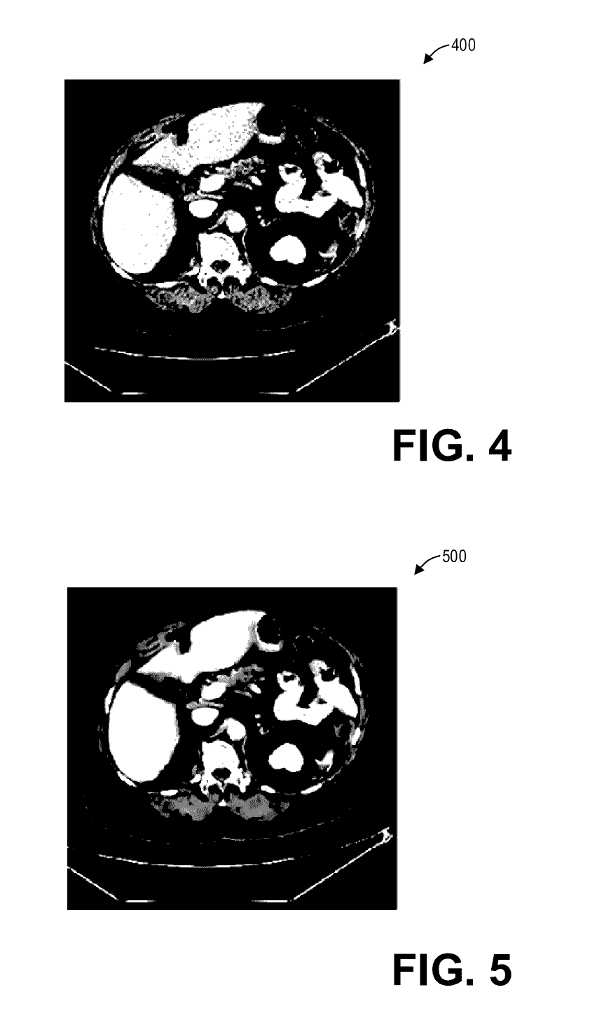

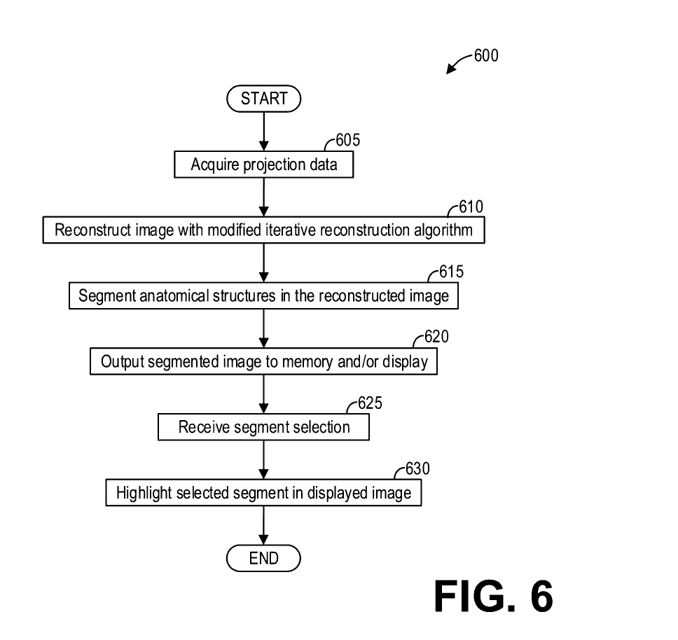

The following description relates to various embodiments of medical imaging systems. In particular, methods and systems are provided for reconstructing an image with ideal properties for automatic segmentation. An example of a computed tomography (CT) imaging system that may be used to acquire images processed in accordance with the present techniques is provided in FIGS. 1 and 2. A method for automatic segmentation, such as the method shown in FIG. 3, may include reconstructing a first image suitable for diagnostics and a second image suitable for segmentation, and the first image may be segmented based on the segmentation of the second image. FIGS. 4 and 5 show example image reconstructions suitable for diagnostics and segmentation, respectively. When the segmentation of an image takes significant priority over the textural details of an image, a method for automatic segmentation, such as the method shown in FIG. 6, may include reconstructing an image suitable for segmentation and outputting the image after segmentation, rather than applying the segments to a second image.

Though a CT system is described by way of example, it should be understood that the present techniques may also be useful when applied to images acquired using other imaging modalities, such as tomosynthesis, MRI, C-arm angiography, and so forth. The present discussion of a CT imaging modality is provided merely as an example of one suitable imaging modality.

FIG. 1 illustrates an exemplary CT system 100 configured to allow fast and iterative image reconstruction. Particularly, the CT system 100 is configured to image a subject such as a patient, an inanimate object, one or more manufactured parts, and/or foreign objects such as dental implants, stents, and/or contrast agents present within the body. In one embodiment, the CT system 100 includes a gantry 102, which in turn, may further include at least one x-ray radiation source 104 configured to project a beam of x-ray radiation 106 for use in imaging the patient. Specifically, the radiation source 104 is configured to project the x-rays 106 towards a detector array 108 positioned on the opposite side of the gantry 102. Although FIG. 1 depicts only a single radiation source 104, in certain embodiments, multiple radiation sources may be employed to project a plurality of x-rays 106 for acquiring projection data corresponding to the patient at different energy levels.

In certain embodiments, the CT system 100 further includes an image processing unit 110 configured to reconstruct images of a target volume of the patient using an iterative or analytic image reconstruction method. For example, the image processing unit 110 may use an analytic image reconstruction approach such as filtered backprojection (FBP) to reconstruct images of a target volume of the patient. As another example, the image processing unit 110 may use an iterative image reconstruction approach such as advanced statistical iterative reconstruction (ASIR), conjugate gradient (CG), maximum likelihood expectation maximization (MLEM), model-based iterative reconstruction (MBIR), and so on to reconstruct images of a target volume of the patient.

FIG. 2 illustrates an exemplary imaging system 200 similar to the CT system 100 of FIG. 1. In accordance with aspects of the present disclosure, the system 200 is configured to reconstruct images with a user-specified temporal window in real-time. In one embodiment, the system 200 includes the detector array 108 (see FIG. 1). The detector array 108 further includes a plurality of detector elements 202 that together sense the x-ray beams 106 (see FIG. 1) that pass through a subject 204 such as a patient to acquire corresponding projection data. Accordingly, in one embodiment, the detector array 108 is fabricated in a multi-slice configuration including the plurality of rows of cells or detector elements 202. In such a configuration, one or more additional rows of the detector elements 202 are arranged in a parallel configuration for acquiring the projection data.

In certain embodiments, the system 200 is configured to traverse different angular positions around the subject 204 for acquiring desired projection data. Accordingly, the gantry 102 and the components mounted thereon may be configured to rotate about a center of rotation 206 for acquiring the projection data, for example, at different energy levels. Alternatively, in embodiments where a projection angle relative to the subject 204 varies as a function of time, the mounted components may be configured to move along a general curve rather than along a segment of a circle.

In one embodiment, the system 200 includes a control mechanism 208 to control movement of the components such as rotation of the gantry 102 and the operation of the x-ray radiation source 104. In certain embodiments, the control mechanism 208 further includes an x-ray controller 210 configured to provide power and timing signals to the radiation source 104. Additionally, the control mechanism 208 includes a gantry motor controller 212 configured to control a rotational speed and/or position of the gantry 102 based on imaging requirements.

In certain embodiments, the control mechanism 208 further includes a data acquisition system (DAS) 214 configured to sample analog data received from the detector elements 202 and convert the analog data to digital signals for subsequent processing. The data sampled and digitized by the DAS 214 is transmitted to a computing device 216. In one example, the computing device 216 stores the data in a storage device 218. The storage device 218, for example, may include a hard disk drive, a floppy disk drive, a compact disk-read/write (CD-R/W) drive, a Digital Versatile Disc (DVD) drive, a flash drive, and/or a solid-state storage device.

Additionally, the computing device 216 provides commands and parameters to one or more of the DAS 214, the x-ray controller 210, and the gantry motor controller 212 for controlling system operations such as data acquisition and/or processing. In certain embodiments, the computing device 216 controls system operations based on operator input. The computing device 216 receives the operator input, for example, including commands and/or scanning parameters via an operator console 220 operatively coupled to the computing device 216. The operator console 220 may include a keyboard (not shown) or a touchscreen to allow the operator to specify the commands and/or scanning parameters.

Although FIG. 2 illustrates only one operator console 220, more than one operator console may be coupled to the system 200, for example, for inputting or outputting system parameters, requesting examinations, and/or viewing images. Further, in certain embodiments, the system 200 may be coupled to multiple displays, printers, workstations, and/or similar devices located either locally or remotely, for example, within an institution or hospital, or in an entirely different location via one or more configurable wired and/or wireless networks such as the Internet and/or virtual private networks.

In one embodiment, for example, the system 200 either includes, or is coupled to a picture archiving and communications system (PACS) 224. In an exemplary implementation, the PACS 224 is further coupled to a remote system such as a radiology department information system, hospital information system, and/or to an internal or external network (not shown) to allow operators at different locations to supply commands and parameters and/or gain access to the image data.

The computing device 216 uses the operator-supplied and/or system-defined commands and parameters to operate a table motor controller 226, which in turn, may control a motorized table 228. Particularly, the table motor controller 226 moves the table 228 for appropriately positioning the subject 204 in the gantry 102 for acquiring projection data corresponding to the target volume of the subject 204.

As previously noted, the DAS 214 samples and digitizes the projection data acquired by the detector elements 202. Subsequently, an image reconstructor 230 uses the sampled and digitized x-ray data to perform high-speed reconstruction. Although FIG. 2 illustrates the image reconstructor 230 as a separate entity, in certain embodiments, the image reconstructor 230 may form part of the computing device 216. Alternatively, the image reconstructor 230 may be absent from the system 200 and instead the computing device 216 may perform one or more functions of the image reconstructor 230. Moreover, the image reconstructor 230 may be located locally or remotely, and may be operatively connected to the system 100 using a wired or wireless network. Particularly, one exemplary embodiment may use computing resources in a “cloud” network cluster for the image reconstructor 230.

In one embodiment, the image reconstructor 230 stores the images reconstructed in the storage device 218. Alternatively, the image reconstructor 230 transmits the reconstructed images to the computing device 216 for generating useful patient information for diagnosis and evaluation. In certain embodiments, the computing device 216 transmits the reconstructed images and/or the patient information to a display 232 communicatively coupled to the computing device 216 and/or the image reconstructor 230.

The various methods and processes described further herein may be stored as executable instructions in non-transitory memory on a computing device in system 200. In one embodiment, image reconstructor 230 may include such instructions in non-transitory memory, and may apply the methods described herein to reconstruct an image from scanning data. In another embodiment, computing device 216 may include the instructions in non-transitory memory, and may apply the methods described herein, at least in part, to a reconstructed image after receiving the reconstructed image from image reconstructor 230. In yet another embodiment, the methods and processes described herein may be distributed across image reconstructor 230 and computing device 216.

In one embodiment, the display 232 allows the operator to evaluate the imaged anatomy. The display 232 may also allow the operator to select a volume of interest (VOI) and/or request patient information, for example, via graphical user interface (GUI) for a subsequent scan or processing.

FIG. 3 shows a high-level flow chart illustrating an example method 300 for segmenting a reconstructed image according to an embodiment. In particular, method 300 relates to generating a pair of images from the same projection data, wherein a first image is reconstructed according to a normal iterative reconstruction algorithm and a second image is reconstructed according to a modified iterative reconstruction algorithm. The quality of the first image is suitable for diagnostics but not for automated segmentation, while the quality of the second image is not as suitable as the first image for diagnostics but is well-suited for automated segmentation. Method 300 may be carried out by the components and systems depicted in FIGS. 1 and 2, however it should be understood that the method may be implemented on other components and systems not depicted without departing from the scope of the present disclosure.

Method 300 may begin at 305. At 305, method 300 may include acquiring projection data. Projection data may be acquired over at least a full rotation (360°) of the gantry 102. In some examples, acquiring the projection data may further include calibrating the projection data. Calibrating the projection data may include, but is not limited to, applying gain calibrations and adjustments to the projection data to prepare the projection data for image reconstruction.

Method 300 may then proceed to 310. At 310, method 300 may include reconstructing a first image with a normal iterative reconstruction algorithm. In iterative reconstruction, an image is estimated by successively updating the image to find the solution which best matches the acquired data according to a model of the operation of the CT system. Exemplary iterative reconstruction algorithms which may be used to reconstruct the first image may include, but are not limited to, advanced statistical iterative reconstruction (ASIR), model-based iterative reconstruction (MBIR), and so on. In such exemplary iterative reconstruction algorithms, the image is reconstructed by minimizing a cost function such as:

$$\hat{x} = arg {min}_{x} \{ L ( Ax , y ) + α G ( x ) \} ,$$

where \hat{x} represents the estimated object at the current iteration (i.e., the latest iteration of the image), x represents the estimated object at the previous iteration (i.e., the previous iteration of the image), A is a system matrix depicting the mapping process from the reconstructed image voxel to the projection (i.e., a linearized model of the imaging system), and y is the measured projection. The log-likelihood function L (Ax, y) deals with the fidelity of the reconstructed image as compared to the original image by penalizing the differences between the image x and the projection data y, while the regularization function G(x) deals with the neighborhood smoothness of the reconstructed images.

At 315, method 300 may include reconstructing a second image with a modified iterative reconstruction algorithm. In particular, the modified iterative reconstruction algorithm comprises the iterative reconstruction algorithm employed at 310 with various modifications that prioritize smoothness of the reconstructed image over accuracy of textural details. As a result, intensity fluctuations in the second image may be substantially reduced or eliminated altogether, and so the second image may be relatively smooth and flat compared to the first image. To that end, the iterative reconstruction algorithm utilized at 310 may be modified such that:

$$\hat{x} = arg {min}_{x} \{ {β}_{i} \cdot L ( {A}^{″} x , {y}^{″} ) + {α}_{i} \cdot G ( x ) \} ,$$

where A″ is a modified system matrix, y″ is a modified projection measurement, and the new parameters αᵢ and βᵢ are dependent on the iteration index i. Note that the log-likelihood function L(Ax,y) is modified to L(A″x,y″), where the modified system matrix A″ deprioritizes spatial resolution. Each new voxel corresponds to a bigger area as compared to the original image, and the same is applicable to the projection samples (i.e., each sample covers an area larger than the detector cell). The parameter αᵢ is significantly increased as compared to the normal iterative reconstruction process so that the image smoothness (i.e., the regularization function) becomes the more dominating factor compared to the log-likelihood function. The parameter αᵢ is also iteration-dependent together with the parameter βᵢ. In order to fully prioritize image smoothness, the parameter may generally be zero with only an occasional non-zero value. In other words, additional iterations may be rendered on the image regularization under the constraint to ensure the noise-induced intensity fluctuation is reduced to a minimum. In an extreme case, the parameter βᵢ may be zero for all iterations i such that only image-space regularization is performed. Further, a smoothing constraint is imposed on each iteration with respect to the initial iteration:

∥F(x)−F(x₀)∥≦ε,

where F is a smoothing function and ε is an infinitesimal number. The smoothing function F ensures that the average of x in the small neighborhood is approximately (i.e., up to a difference of ε) the same as the average of the original estimation of the object x₀.

FIGS. 4 and 5 show example images of an abdomen reconstructed from the same scan data using a normal iterative reconstruction algorithm and a modified iterative reconstruction algorithm, respectively. In particular, FIG. 4 shows an example image 400 reconstructed using the normal iterative reconstruction algorithm described at 310, and FIG. 5 shows an example image 500 reconstructed using the modified iterative reconstruction algorithm described at 315. Specifically, image 400 is reconstructed using ASIR while image 500 is reconstructed using modified ASIR. Comparing the two images, the flatness of the reconstructed image 500 in relatively flat anatomies may be nearly noise free compared to the reconstructed image 400. The intensity across the anatomical structures in image 500 is nearly constant, removing all fluctuations in the intensity. The intensity fluctuations across the anatomical structures in image 400 poses technical issues for automatic segmentation, and may result in incorrectly segmented organs and other structures within the image 400. In contrast, the constant intensity of each anatomical structure in image 500 is ideal for automatic segmentation.

Returning to FIG. 3, after the second image is reconstructed at 310, method 300 may continue to 320. At 320, method 300 may include segmenting the anatomical structures in the second image. Image segmentation comprises partitioning an image into a plurality of segments, each segment containing a plurality of voxels. As the second image includes a minimal amount of intensity fluctuations and noise, any suitable automatic segmentation process may be applied to the second image to obtain accurate segments. In one example, a simple threshold segmentation process may be applied to the second image. For example, a suitable threshold image segmentation process may include clustering, edge detection, histogram-based methods, entropy-based methods, local threshold methods, spatial methods, attribute methods, and so on.

At 325, method 300 may include applying segmentation to the first image based on the segmentation of the second image. In particular, applying segmentation to the first image does not comprise applying an automatic segmentation process to the first image. Rather, the first image may be segmented according to the segmentation of the second image. For example, the segments obtained during automatic segmentation of the second image may be applied to the first image such that the first image is segmented according to the segmentation of the second image. In one example, applying segmentation to the first image may comprise applying the boundaries obtained in segmenting the second image to the first image. In this way, the first image may be segmented regardless of the image quality of the first image, which may otherwise negatively affect any automatic segmentation applied to the first image.

After the segmentation of the second image is applied to the first image, the second image may be discarded. Thus, continuing at 330, method 300 may include discarding the second image and associated data. In this way, memory usage may be reduced.

At 335, method 300 may include outputting the segmented first image to memory and/or a display for review. For example, the segmented first image may be stored in memory, such as the mass storage 218, for retrieval at a later time. Additionally or alternatively, the segmented image may be output to a display, such as display 232, for display to a user of the imaging system 200, such as a radiologist or physician.

At 340, method 300 may include receiving a segment selection. A segment selection may comprise a selection of one or more segments of the plurality of segments in the segmented first image. In one example, the segment selection may be received from the operator console 220. For example, a user of the imaging system 200 may desire to highlight a particular segment of the image, and so may select the particular segment via the operator console 220. As an illustrative and non-limiting example, the user may select a segment associated with a tumor located in the image in order to emphasize the location of the tumor.

In another example, the segment selection may be automatically generated. For example, a machine learning algorithm (e.g., a classification algorithm) may be applied to the segmented first image to automatically identify an atypical segment. To that end, such a machine learning algorithm may identify segments associated with anatomical structures expected in the image, and may return any segments which are not associated with standard anatomical structures. Therefore, in such an example, the segment selection may be generated by and received from the computer 216 itself.

At 345, method 300 may include highlighting the selected segment in the displayed image. Highlighting the selected segment may comprise any suitable method of emphasizing the selected segment to the user. For example, highlighting the selected segment may comprise applying a color to the boundary of the selected segment. As another example, highlighting the selected segment may comprise reducing the brightness of the entire image aside from the selected segment while maintaining the original brightness of the selected segment. In this way, the selected segment may be easily identified by a user amongst unselected segments. Method 300 may then end.

Thus, a method comprises generating a first image from acquired projection data based on an iterative reconstruction algorithm, generating a second image from the acquired projection data based on a modified iterative reconstruction algorithm, segmenting the second image to obtain segments, segmenting the first image based on the segments of the second image, and outputting the segmented first image to a display.

FIG. 6 shows a high-level flow chart illustrating an example method 600 for generating a segmented image. In particular, method 600 relates to reconstructing an image with a modified iterative reconstruction algorithm, wherein the modifications to the algorithm enable an automatic segmentation algorithm to correctly segment structures within the image. In some examples, the segmentation of an image may be a greater priority than the textural details obtained using a normal iterative reconstruction algorithm. For example, the image 500 reconstructed for automatic segmentation may be sufficient for the purposes of an oncologist, who may not find the additional detail of the image 400 particularly useful. To that end, method 600 does not include the reconstruction of a second image using a normal or unmodified iterative reconstruction algorithm. Method 600 may be carried out by the components and systems depicted in FIGS. 1 and 2, however it should be understood that the method may be implemented on other components and systems not depicted without departing from the scope of the present disclosure.

Method 600 may begin at 605. At 605, method 600 may include acquiring projection data. Projection data may be acquired over at least a full rotation (360°) of the gantry 102. In some examples, acquiring the projection data may further include calibrating the projection data. Calibrating the projection data may include, but is not limited to, applying gain calibrations and adjustments to the projection data to prepare the projection data for image reconstruction.

At 610, method 600 may include reconstructing an image with a modified iterative reconstruction algorithm. The modified iterative reconstruction algorithm may be substantially similar to the modified iterative reconstruction algorithm described herein above at 315 with regard to FIG. 3. In particular, as described herein above, modifications to a normal iterative reconstruction algorithm may be designed to prioritize smoothness of the reconstructed image over accuracy of textural details.

At 615, method 600 may include segmenting anatomical structures in the reconstructed image. Image segmentation comprises partitioning an image into a plurality of segments, each segment containing a plurality of voxels. In one example, a simple threshold segmentation process may be applied to the second image. For example, a suitable threshold image segmentation process may include clustering, edge detection, histogram-based methods, entropy-based methods, local threshold methods, spatial methods, attribute methods, and so on.

At 620, method 600 may include outputting the segmented image to memory and/or display. For example, the segmented image may be stored in memory, such as the mass storage 218, for retrieval at a later time. Additionally or alternatively, the segmented image may be output to a display, such as display 232, for display to a user of the imaging system 200, such as a radiologist or physician.

At 625, method 600 may include receiving a segment selection. A segment selection may comprise a selection of one or more segments of the plurality of segments in the segmented image. In one example, the segment selection may be received from the operator console 220. For example, a user of the imaging system 200 may desire to highlight a particular segment of the image, and so may select the particular segment via the operator console 220. As an illustrative and non-limiting example, the user may select a segment associated with a tumor located in the image in order to emphasize the location of the tumor.

In another example, the segment selection may be automatically generated. For example, a machine learning algorithm (e.g., a classification algorithm) may be applied to the segmented image to automatically identify an atypical segment. To that end, such a machine learning algorithm may identify segments associated with anatomical structures expected in the image, and may return any segments which are not associated with standard anatomical structures. Therefore, in such an example, the segment selection may be generated by and received from the computer 216 itself.

At 630, method 600 may include highlighting the selected segment in the displayed image. Highlighting the selected segment may comprise any suitable method of emphasizing the selected segment to the user. For example, highlighting the selected segment may comprise applying a color to the boundary of the selected segment. As another example, highlighting the selected segment may comprise reducing the brightness of the entire image aside from the selected segment while maintaining the original brightness of the selected segment. In this way, the selected segment may be easily identified by a user amongst unselected segments. Method 600 may then end.

Thus, a method comprises generating an image from acquired projection data based on a modified iterative reconstruction algorithm, the modified iterative reconstruction algorithm comprising an iterative reconstruction algorithm with a modified system matrix, segmenting the image, and outputting the segmented image to a display.

A technical effect of the disclosure is the modification of an iterative reconstruction algorithm to constrain intensity fluctuations in reconstructed images. Another technical effect of the disclosure is the reconstruction of images with constrained intensity fluctuations. Yet another technical effect of the disclosure is the automatic segmentation of an image reconstructed with constrained intensity fluctuations. Another technical effect of the disclosure is the display of a segmented image, wherein a particular segment selected by a user is highlighted in the displayed image.

In one embodiment, a method comprises generating a first image from acquired projection data based on an iterative reconstruction algorithm, generating a second image from the acquired projection data based on a modified iterative reconstruction algorithm, segmenting the second image to obtain segments, segmenting the first image based on the segments of the second image, and outputting the segmented first image to a display.

In one example, the modified iterative reconstruction algorithm comprises the iterative reconstruction algorithm with a modified system matrix. In another example, the modified iterative reconstruction algorithm further comprises the iterative reconstruction algorithm with a modified projection. In yet another example, the modified iterative reconstruction algorithm includes a constraint operator configured to ensure that an average estimation of an object is within a threshold range of an original average estimation of the object.

In one example, the method further comprises discarding the second image after obtaining the segments. In this way, digital memory may be conserved.

In another example, the method further comprises receiving a selection of a segment and highlighting the selected segment in the segmented first image output to the display. For example, highlighting the selected segment comprises applying an outline to a boundary of the selected segment.

As another example, segmenting the second image comprises applying a threshold segmentation to the second image. In one example, segmenting the first image comprises applying segment boundaries of the segments to the first image.

In another embodiment, a method comprises generating an image from acquired projection data based on a modified iterative reconstruction algorithm, the modified iterative reconstruction algorithm comprising an iterative reconstruction algorithm with a modified system matrix, segmenting the image, and outputting the segmented image to a display.

In one example, the modified iterative reconstruction algorithm further comprises the iterative reconstruction algorithm with a modified projection. As another example, the modified iterative reconstruction algorithm includes a constraint operator configured to ensure that an average estimation of an object is within a threshold range of an original average estimation of the object.

In one example, segmenting the image comprises applying a threshold segmentation to the image. In another example, the method further comprises receiving a selection of a segment and highlighting the selected segment in the segmented image output to the display. For example, highlighting the selected segment comprises applying an outline to a boundary of the selected segment.

In yet another embodiment, a system comprises an x-ray source that emits a beam of x-rays toward an object to be imaged, a detector that receives the x-rays attenuated by the object, and a data acquisition system (DAS) operably connected to the detector. The system further comprises a computer operably connected to the DAS and configured with instructions in non-transitory memory that when executed cause the computer to generate an image from projection data received from the DAS based on a modified iterative reconstruction algorithm, the modified iterative reconstruction algorithm including a modified system matrix, and segment the image into a plurality of segments.

In one example, the system further comprises a display, and the computer is further configured with instructions in the non-transitory memory that when executed cause the computer to output the segmented image to the display.

In another example, the system further comprises an operator console operably connected to the computer and configured to receive user input, and the computer is further configured with instructions in the non-transitory memory that when executed cause the computer to receive a selection of at least one segment of the plurality of segments from the operator console, and highlight the at least one segment in the image output to the display.

In one example, the modified iterative reconstruction algorithm further includes a modified projection. In another example, the modified iterative reconstruction algorithm includes a constraint operator configured to ensure that an average estimation of an object is within a threshold range of an original average estimation of the object.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
generating a first image from acquired projection data based on an iterative reconstruction algorithm;
generating a second image from the acquired projection data based on a modified iterative reconstruction algorithm;
segmenting the second image to obtain segments;
segmenting the first image based on the segments of the second image; and
outputting the segmented first image to a display.

2. The method of claim 1, wherein the modified iterative reconstruction algorithm comprises the iterative reconstruction algorithm with a modified system matrix.

3. The method of claim 2, wherein the modified iterative reconstruction algorithm further comprises the iterative reconstruction algorithm with a modified projection.

4. The method of claim 1, wherein the modified iterative reconstruction algorithm includes a constraint operator configured to ensure that an average estimation of an object is within a threshold range of an original average estimation of the object.

5. The method of claim 1, further comprising discarding the second image after obtaining the segments.

6. The method of claim 1, further comprising receiving a selection of a segment and highlighting the selected segment in the segmented first image output to the display.

7. The method of claim 6, wherein highlighting the selected segment comprises applying an outline to a boundary of the selected segment.

8. The method of claim 1, wherein segmenting the second image comprises applying a threshold segmentation to the second image.

9. The method of claim 1, wherein segmenting the first image comprises applying segment boundaries of the segments to the first image.

10. A method, comprising:
generating an image from acquired projection data based on a modified iterative reconstruction algorithm, the modified iterative reconstruction algorithm comprising an iterative reconstruction algorithm with a modified system matrix;
segmenting the image; and
outputting the segmented image to a display.

11. The method of claim 10, wherein the modified iterative reconstruction algorithm further comprises the iterative reconstruction algorithm with a modified projection.

12. The method of claim 10, wherein the modified iterative reconstruction algorithm includes a constraint operator configured to ensure that an average estimation of an object is within a threshold range of an original average estimation of the object.

13. The method of claim 10, wherein segmenting the image comprises applying a threshold segmentation to the image.

14. The method of claim 10, further comprising receiving a selection of a segment and highlighting the selected segment in the segmented image output to the display.

15. The method of claim 14, wherein highlighting the selected segment comprises applying an outline to a boundary of the selected segment.

16. A system, comprising:
an x-ray source that emits a beam of x-rays toward an object to be imaged;
a detector that receives the x-rays attenuated by the object;
a data acquisition system (DAS) operably connected to the detector; and
a computer operably connected to the DAS and configured with instructions in non-transitory memory that when executed cause the computer to:
generate an image from projection data received from the DAS based on a modified iterative reconstruction algorithm, the modified iterative reconstruction algorithm including a modified system matrix; and
segment the image into a plurality of segments.

17. The system of claim 16, further comprising a display, and wherein the computer is further configured with instructions in the non-transitory memory that when executed cause the computer to output the segmented image to the display.

18. The system of claim 17, further comprising an operator console operably connected to the computer and configured to receive user input, and wherein the computer is further configured with instructions in the non-transitory memory that when executed cause the computer to:
receive a selection of at least one segment of the plurality of segments from the operator console; and
highlight the at least one segment in the image output to the display.

19. The system of claim 16, wherein the modified iterative reconstruction algorithm further includes a modified projection.

20. The system of claim 16, wherein the modified iterative reconstruction algorithm includes a constraint operator configured to ensure that an average estimation of an object is within a threshold range of an original average estimation of the object.
